(19) United States
(12) Patent Application Publication
(10) Pub. No.: US 2023/0290263 A1
(43) Pub. Date: Sep. 14, 2023

(54) FLEET SELECTABLE VIRTUAL REALITY LEARNING ENVIRONMENT WITH LEARNING MANAGEMENT SYSTEM

(71) Applicant: Caterpillar Paving Products Inc., Brooklyn Park, MN (US)

(72) Inventors: David A. King, Blaine, MN (US); Eric Remboldt, Rapid City, SD (US); Matt Peasley, Rapid City, SD (US); Todd Willis Mansell, Rogers, MN (US); James A. Delong, Brooklyn Park, MN (US)

(73) Assignee: Caterpillar Paving Products Inc., Brooklyn Park, MN (US)

(21) Appl. No.: 17/693,189

(22) Filed: Mar. 11, 2022

(51) Int. Cl. G09B 9/052

(52) U.S. Cl. CPC G09B 9/052

(57) ABSTRACT

Aspects disclosed herein provide a learning management system associated with a learning environment. The learning management system may be accessed via a credentialed sign-in procedure. Once the credentials are verified, a user may be provided a tailored experience based on their account. The learning management system may provide offerings of different training scenarios and also for tracking and reviewing of assessments associated with completed training scenarios.

### BACKGROUND

### Field of the Invention

The embodiments described herein are generally directed to an image display system and, more particularly, to a system utilizing virtual reality to track and document user training in a learning management system.

### Description of the Related Art

Operators of a machine at a work site may be trained to operate the respective machine. Some work sites may have dozens of workers who may operate a subset of the machine at the work site. As the size of a customer (e.g., a manager of the work site) in terms of machines and or operators, it may become different to determine which operators (or users) have been trained on which machines and with which training scenarios.

In some examples, a work site may include or have access to a standalone training device provided for the purpose of training a potential operator on the use of a machine, such as an asphalt compactor. However, such standalone training devices may be associated with a large acquisition cost and, thus, may be an impractical solution for use in certain work sites. In some examples, the provider or manufacturer of the machine may provide training sessions on how to operate the machine. However, such training sessions may be provided at fixed intervals (e.g., one a month, etc.) and/or may need the potential operator to travel to attend the training sessions.

Virtual reality based techniques provide opportunities for simulating training of a working machine. For example, U.S. Pat. No. 7,171,344 describes a system for providing end-user visualization, Chinese Patent Publication No. CN105448158A describes a simulation training system for working machinery that may verify a user via credentials, and Korean Patent Publication No. KR102089374B1 describes a machine training system that provides training to registered trainees. However, none of these references address a learning management system associated with a learning environment that provides a tailored experience based on an account accessed via a credentialed sign-in procedure, for example, where different training options are made available to be assigned to users based on their account and where tracking and reviewing of assessments for completed training scenarios are available.

The present disclosure is directed toward overcoming one or more of the obstacles to facilitating a learning management system with a fleet selectable virtual reality learning environment to offer training scenarios and to track completed training sessions at a training session level, at a user level, at a machine level, and/or at a fleet level.

### SUMMARY

Accordingly, a learning management system with a fleet selectable virtual reality learning environment to offer training scenarios and to track completed training sessions at a training session level, at a user level, at a machine level, and/or at a fleet level.

In an embodiment, a computer-implemented method for training scenarios, includes: performing a credentialed sign-in procedure based on credentials associated with a user account; outputting at least one training option based on the user account when the credentials are verified; and collecting information related to a first training option when the first training option is selected, the information including at least one of a user assignment or an assessment.

In an embodiment, a system for training scenarios, includes: memory; and at least one processor coupled to the memory. The at least one processor may be configured to: perform a credentialed sign-in procedure based on credentials associated with a user account; output at least one training option based on the user account when the credentials are verified; and collect information related to a first training option when the first training option is selected, the information including at least one of a user assignment or an assessment.

In an embodiment, a non-transitory computer-readable medium having instructions stored therein, wherein the instructions, when executed, cause the processor to: perform a credentialed sign-in procedure based on credentials associated with a user account; output at least one training option based on the user account when the credentials are verified; and collect information related to a first training option when the first training option is selected, the information including at least one of a user assignment or an assessment.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example infrastructure in which one or more of the processes described may be implemented, in accordance with various aspects of the present disclosure.

FIG. 2 is a diagrammatic perspective view of a user system, in accordance with various aspects of the present disclosure.

FIG. 3 illustrates an example processing system by which one or more of the processes described herein may be executed, in accordance with various aspects of the present disclosure.

FIG. 4 illustrates a process for facilitating a fleet selectable learning environment with a learning management system, in accordance with various aspects of the present disclosure.

FIG. 5 illustrates an example machines fleet including one or more selectable machines, in accordance with various aspects of the present disclosure.

FIG. 6 illustrates a graphical user interface including a field of view of a customer sitting in a virtual operator station of a machine, in accordance with various aspects of the present disclosure.

FIG. 7 illustrates an example login window to facilitate a credentialed sign-in procedure, in accordance with various aspects of the present disclosure.

FIG. 8 illustrates a process for facilitating a fleet selectable learning environment with a learning management system, in accordance with various aspects of the present disclosure.

FIG. 9A illustrates a GUI including customer machine fleet, in accordance with various aspects of the present disclosure.

FIG. 9B illustrates a GUI illustrating available training options, in accordance with various aspects of the present disclosure.

FIG. 10 illustrates a GUI including a training session allocation window, in accordance with various aspects of the present disclosure.

FIG. 11A illustrates a GUI including training information collected at a training session level, in accordance with various aspects of the present disclosure.

FIG. 11B illustrates a GUI including training information collected at a user level, in accordance with various aspects of the present disclosure.

FIG. 11C illustrates a GUI including training information collected at a machine level, in accordance with various aspects of the present disclosure.

FIG. 12 illustrates a process for facilitating a fleet selectable learning environment with a learning management system, in accordance with various aspects of the present disclosure.

### DETAILED DESCRIPTION

The detailed description set forth below, in connection with the accompanying drawings, is intended as a description of various embodiments, and is not intended to represent the only embodiments in which the disclosure may be practiced. The detailed description includes specific details for the purpose of providing a thorough understanding of the embodiments. However, it will be apparent to those skilled in the art that embodiments of the invention can be practiced without these specific details. In some instances, well-known structures and components are shown in simplified form for brevity of description.

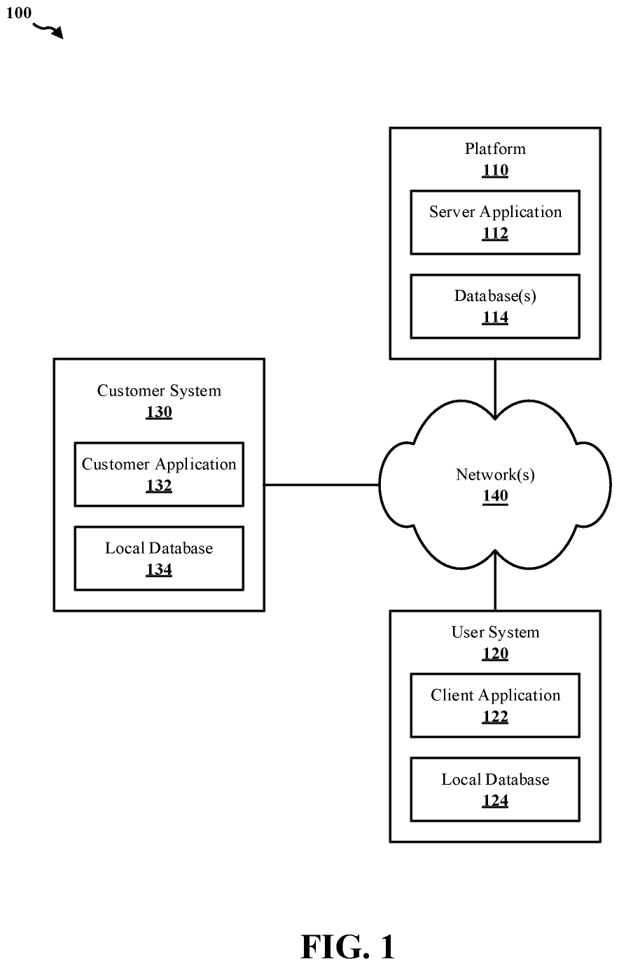

FIG. 1 illustrates an example infrastructure 100 in which one or more of the disclosed processes may be implemented, according to an embodiment. The infrastructure 100 may comprise a platform 110 (e.g., one or more servers) that hosts and/or executes one or more of the various functions, processes, methods, and/or software modules described herein. The platform 110 may comprise dedicated servers, or may instead comprise cloud instances, which utilize shared resources of one or more servers. These servers or cloud instances may be collocated and/or geographically distributed. The platform 110 may also comprise or be communicatively connected to a server application 112 and/or one or more databases 114. In addition, the platform 110 may be communicatively connected to a user system 120 and/or a customer system 130 via a network 140. While only a single instance of the user system 120 and the customer system 130 are illustrated in the example of FIG. 1, other example infrastructures may comprise any number of user systems that are communicatively coupled to the platform 110 via the network 140.

The network 140 may include the Internet, and the platform 110 may communicate with the user system 120 and/or the customer system 130 through the Internet using standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. While the platform 110 is illustrated as being connected to the user system 120 and/or the customer system 130 through a single set of the network 140, in other examples, the platform 110 may be connected to the user system 120 and/or the customer system 130 via different sets of one or more networks. For example, the platform 110 may be connected to a first subset of user systems and/or customer systems via the Internet, but may be connected to a second subset of user systems and/or customer systems via an intranet. It should be appreciated that the first subset and the second subset may include any suitable quantity of user systems and/or customer systems that overlap, such as zero, one, two, etc. user systems.

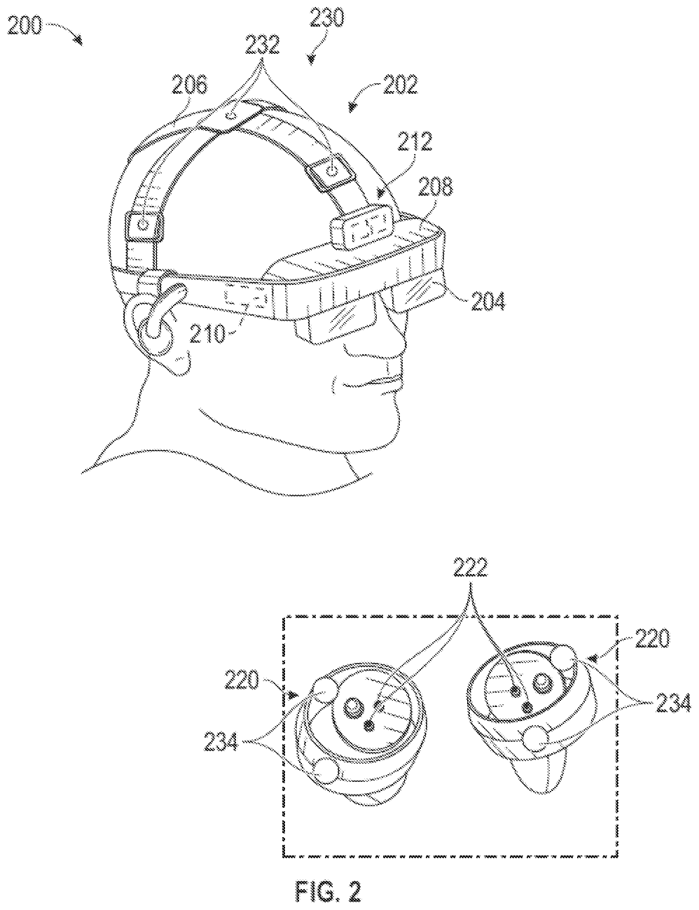

Each user system 120 may comprise any type of computing device capable of wired and/or wireless communication, including without limitation, desktop computers, laptop computers, tablet computers, smart phones or other mobile phones, servers, game consoles, televisions, set-top boxes, electronic kiosks, point-of-sale terminals, and/or the like. However, it is generally contemplated that each user system 120 includes a VR stand-alone headset including a head mountable display device and at least one hand controller, as described in connection with an example user system 200 of FIG. 2. Different users with different roles will utilize their particular user system to interact with the server application 112 on the platform 110 and/or the customer system 130 in accordance with their individual roles. For example, an administer may utilize an administer user system, and an operator may utilize an operator user system. The administer user system may enable the administer, sometimes referred to herein as a “training manager” or a “training coordinator,” to populate users who may access the operator user system, allocate one or more training sessions to the different users, and/or access assessments of users who completed training sessions. The operator user system may enable a user to access their profile via a credentialed sign-in procedure, identify any training sessions allocated to the user, access the respective training sessions, and/or receive feedback on their performance of completed training sessions.

As shown in FIG. 1, the user system 120 may comprise or be communicatively connected to a client application 122 and/or one or more local databases 124. The client application 122 may include an operator training application configured to provide machine walkarounds, machine operation training, and application training to the user for a respective machine based on allocated training sessions.

Each customer system 130 may comprise any type of computing device capable of wired and/or wireless communication, including without limitation, desktop computers, laptop computers, tablet computers, smart phones or other mobile phones, servers, game consoles, televisions, set-top boxes, electronic kiosks, point-of-sale terminals, and/or the like. Similar to the user system 120, different users with different roles will utilize their particular customer system to interact with the server application 112 on the platform 110 and/or the user system 120 in accordance with their individual roles. For example, an administer may utilize an administer user system, and an operator may utilize an operator user system. The administer user system may enable the administer, sometimes referred to herein as a “training manager” or a “training coordinator,” to populate users who may access the operator user system, allocate one or more training sessions to the different users, and/or access assessments of users who completed training sessions. The operator user system may enable a user to access their profile via a credentialed sign-in procedure, identify any training sessions allocated to the user, access the respective training sessions, and/or receive feedback on their performance of completed training sessions.

As shown in FIG. 1, the customer system 130 may comprise or be communicatively connected to a customer application 132 and/or one or more local databases 134. The customer application 132 may include an operator training application configured to provide machine walkarounds, machine operation training, and application training to the user for a respective machine based on allocated training sessions.

The platform 110 may include web servers that host one or more websites and/or web services. In embodiments in which a website is provided, the website may comprise a graphical user interface, including, for example, one or more screens (e.g., webpages) generated in HyperText Markup Language (HTML) or other language. The platform 110 transmits or serves one or more screens of the graphical user interface, which may be generated by the server application 112, in response to requests from the user system 120 and/or the customer system 130. In some embodiments, these screens may be served in the form of a wizard, in which case two or more screens may be served in a sequential manner, and one or more of the sequential screens may depend on an interaction of the user or the user system 120 and/or the customer system 130 with one or more preceding screens. The requests to the platform 110 and the responses from the platform 110, including the screens of the graphical user interface, may both be communicated through the network 140, which may include the Internet, using standard communication protocols (e.g., HTTP, HTTPS, etc.). These screens (e.g., webpages) may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in one or more databases (e.g., the one or more databases 114) that are locally and/or remotely accessible to the platform 110.

As mentioned above, the platform 110 may comprise, be communicatively coupled with, or otherwise have access to the one or more databases 114. For example, the platform 110 may comprise one or more database servers that manage the one or more databases 114. The server application 112 executing on the platform 110, the client application 122 executing on the user system 120, and/or the customer application 132 executing on the customer system 130 may submit data (e.g., user data, form data, any of the user input or other data described herein, etc.) to be stored in the one or more databases 114, and/or request access to data stored in the one or more databases 114. Any suitable database may be utilized, including without limitation MySQL™ Oracle™, IBM™, Microsoft SQL™, Access™, PostgreSQL™, and the like, including cloud-based databases and proprietary databases. Data may be sent to the platform 110, for instance, using the well-known POST request supported by HTTP, via FTP, and/or the like. This data, as well as other requests, may be handled, for example, by server-side web technology, such as a servlet or other software module (e.g., comprised in the server application 112), executed by the platform 110.

In embodiments in which a web service is provided, the platform 110 may receive requests from external systems, and provide responses in eXtensible Markup Language (XML), JavaScript Object Notation (JSON), and/or any other suitable or desired format. In such embodiments, the platform 110 may provide an application programming interface (API) which defines the manner in which the user system 120, the customer system 130, and/or other external system(s) may interact with the web service. Thus, the user system 120, the customer system 130, and/or the other external systems (which may themselves be servers), can define their own user interfaces, and rely on the web service to implement or otherwise provide the backend processes, methods, functionality, storage, and/or the like, described herein. For example, in such an embodiment, the client application 122, executing on the user system 120, may interact with the server application 112 to execute one or more or a portion of one or more of the various functions, processes, methods, and/or software modules described herein. In this case, the client application 122 may generate the graphical user interface. In an embodiment, the client application 122 may utilize the one or more local databases 124 for storing data locally on the user system 120. In a similar manner, the customer application 132 may utilize the one or more local databases 134 for storing data locally on the customer system 130.

The client application 122 and/or the customer application 132 may be “thin,” in which data processing is primarily carried out server-side by the server application 112 on the platform 110. A basic example of a “thin” client application or a “thin” customer application is a browser application, which simply requests, receives, and renders webpages at the user system 120 or the customer system 130, respectively, while the server application 112 on the platform 110 is responsible for generating the webpages and managing database functions. Alternatively, the client application and/or the customer application may be “thick,” in which case processing is primarily carried out client-side by the user system 120 and/or the customer system 130, respectively. It should be understood that the client application 122 and/or the customer application 132 may perform any amount of processing, relative to the server application 112 on the platform 110, at any point along this spectrum between “thin” and “thick,” depending on the design goals of the particular implementation. In any case, the software described herein, which may wholly reside on either the platform 110 (e.g., in which case the server application 112 performs all processing), the user system 120 (e.g., in which case the client application 122 performs all processing) or the customer system 130 (e.g., in which case the customer application 132 performs all processing), or may be distributed between the platform 110, the user system 120 and/or the customer system 130 (e.g., in which case the server application 112 and the client application 122 and/or the customer application 132 perform processing), can include one or more executable software modules comprising instructions that implement one or more of the processes, methods, or functions described herein.

In some examples in which the user system 120 and the client application 122 have the capability to perform the processing at the user system 120, the user system 120 may be referred to as a “tether-less” system. In other examples in which the user system 120 and/or the client application 122 offload at least a portion of the processing to the server application 112, the user system 120 may be referred to as a “tethered” system. The concepts described herein may be applicable to a tether-less system and to a tethered system.

FIG. 2 illustrates an example of a user system 200 that may implement aspects of the user system 120 of FIG. 1. The user system 200 may be a wearable system that may be implemented via a virtual reality headset that can be deployed to different locations. In the illustrated example of FIG. 2, the user system 200 includes a head mountable display device 202 and hand controls 220 The head mountable display device 202 is configured to display graphical user interfaces on a display screen 204. The graphical user interfaces may include one or more virtual objects (e.g., graphical media content, such as text, images, and/or video) with which the user may interact. In some examples, the display screen 204 may be implemented via a substantially transparent display screen. For example, a substantially transparent display screen may permit the operator to maintain a view of the physical environment while also viewing the virtual objects displayed over the physical field of vision of the operator to augment the image seen by the operator. Such augmented imagery may sometimes be referred to as augmented reality (AR) or augmented vision.

The head mountable display device 202 may include an adjustable strap or harness 206 that allows the head mountable display device 202 to be worn over the head of the user. The head mountable display device 202 may include a visor or goggles 208 with lenses that function as the display screen 204. One or more image projectors 210 may direct the graphical user interfaces onto the display screen 204 within the line of sight of the user.

The one or more image projectors 210 may be an optical projection system, light emitting diode package, optical fibers, or other suitable projector for transmitting a virtual object. The display screen 204 may be configured to reflect the virtual objects from the one or more image projectors 210, for example, by a thin film coating, tinting, polarization, or the like.

The user system 200 includes a headset controller 212 including a processor or other electronics. The headset controller 212 may transmit and receive data between the head mountable display device 202 and the hand controls 220. Additionally, the headset controller 212 may facilitate communication between the user system 200 and the platform 110 of FIG. 1. For example, the headset controller 212 may communicate data from the user system 200 to the platform 110 (e.g., to store user data in the one or more databases 114), and/or may communicate data from the platform 110 to the user system 200 (e.g., to store data related to a user profile, training sessions, etc. in the one or more local databases 124). The headset controller 212 may control the projection of the graphical user interfaces on the display screen 204 and determine the virtual objects to be projected by the one or more image projectors 210.

The hand controls 220 may include virtual reality hand controls. As shown in FIG. 2, the hand controls 220 include one or more navigation controls 222 that facilitate interacting with and navigating through the graphical user interfaces. For example, a first navigation control may enable the user to select a virtual object, a second navigation control may enable the user to return to a previous graphical user interface, a third navigation control may enable the user to pause or stop a training session, etc. When the user engages with one of the one or more navigation controls 222, the hand controls 220 transmit data that is received by the headset controller 212 for processing.

The user system 200 may also include a sensor system 230 used to determine an orientation and a position or pose of the head of the user and the hand(s) of the user. For example, the sensor system 230 may include one or more headset sensors 232 positioned on the head mountable display device 202 that generate signals that the headset controller 212 may use to determine the pose of the head of the operator. The sensor system 230 may also include one or more hand control sensors 234 positioned on the hand controls 220 that generate signals that the headset controller 212 may use to determine the position of the hand(s) of the operator. In some examples, the one or more headset sensors 232 and/or the one or more hand control sensors 234 may be implemented via Hall effect sensors that utilize the variable relative positions of a transducer and a magnetic field to deduce the direction, pitch, yaw, and/or roll of the head and/or the positioning of the hand(s) of the operator. In other examples, the one or more headset sensors 232 and/or the one or more hand control sensors 234 may communicate with a positioning system, such as a global navigation satellite system or a global positioning system, to determine the pose of the head and/or positioning of the hand(s) of the operator.

The data obtained by the one or more headset sensors 232 may be used to determine a specific orientation of the field of view of the user. The data obtained by the one or more hand control sensors 234 may be used to facilitate interaction with images and/or virtual objects displayed via the display screen 204.

As described above, the user system 200 may be used to present graphical user interfaces to a user, for example, to facilitate guided operator training. For example, the user system 200 may execute the client application 122 of FIG. to facilitate training and assessing an operator on their use of a simulated machine. The client application 122 may guide the user (e.g., the operator) through a number of screens including graphical user interfaces. For example, the display screen 204 may display a graphical user interface including one or more virtual objects that the user may interact with via the one or more navigation controls 222 of the hand controls 220. Each of the virtual objects may be associated with unique identifiers, such as a set of coordinates (e.g., Cartesian coordinate data, polar coordinate data, or spherical coordinate data), that define a location of the virtual object relative to the graphical user interface. As the user moves the hand controls 220, the one or more hand control sensors 234 may output data related to the positioning of the hands relative to the displayed graphical user interface. The headset controller 212 may use the unique identifiers associated with the different displayed virtual objects of the graphical user interface and the positioning data provided by the one or more hand control sensors 234 to determine when the operator is interacting with a specific virtual object.

As described above, in some examples, processing of data may be performed by the headset controller 212. In other examples, the headset controller 212 may offload a portion of the data processing to the server application 112 of the platform 110.

The headset controller 212 may execute a client application (e.g., the client application 122) and access the server application 112 to facilitate training and assessing a user via a plurality of graphical user interfaces that guide the user through different screens of the client application.

The graphical user interfaces may be associated with a machine training session that provides a machine walkaround, machine operation training, and application training. The graphical user interfaces may also be associated with providing learning assessments to the user and/or administrators. For example, the graphical user interfaces associated with a machine walkaround may provide training related to different aspects of a machine, such as an asphalt compactor. The graphical user interfaces associated with the machine operation training and application training may provide training related to, for example, asphalt compactor rolling pattern scenarios, paving-by-numbers scenarios, milling-by-numbers scenarios, etc. The graphical user interfaces associated with the learning assessments may provide a score assessment and/or feedback related to operation of the machine by the user after completing the machine training session.

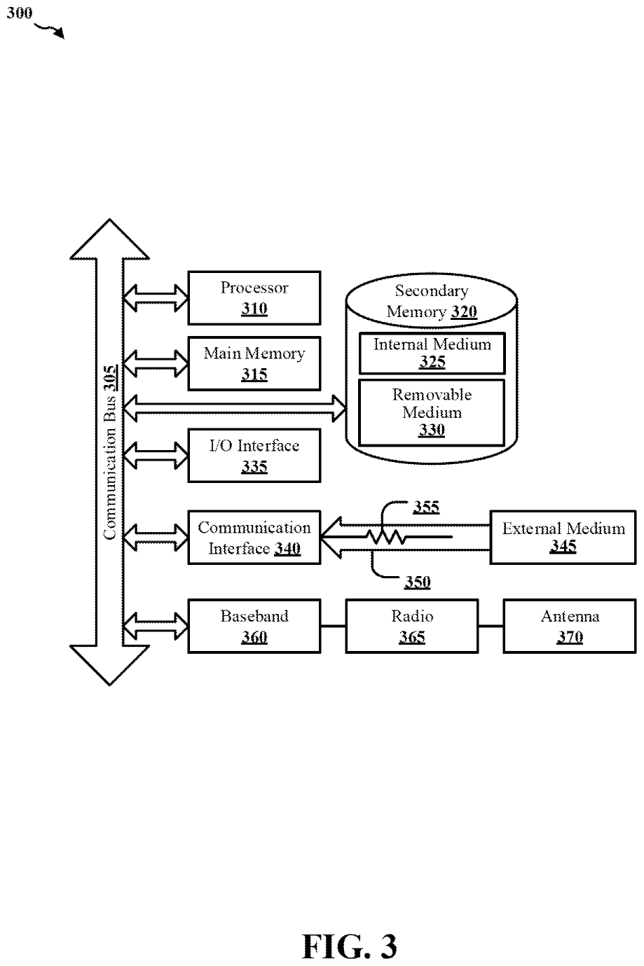

FIG. 3 is a block diagram illustrating an example system 300 that may be used in connection with various embodiments described herein. The system 300 may be a wired system or a wireless system that may be used as or in conjunction with one or more of the functions, processes, or methods (e.g., to store and/or execute the software) described herein, and may represent components of the platform 110, the user system 120, the customer system 130, the network 140, the user system 200, and/or other processing devices described herein. For example, the system 300 may implement the platform 110, may implement the network 140, may implement the customer system 130, and/or may implement the user system 120 of FIG. 1 and/or the user system 200 of FIG. 2. The system 300 can be a server or any conventional personal computer, or any other processor-enabled device that is capable of wired or wireless data communication. Other computer systems and/or architectures may be also used, as will be clear to those skilled in the art.

The system 300 preferably includes a processor 310. The processor 310 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a slave processor subordinate to the main processing system (e.g., back-end processor), an additional microprocessor or controller for dual or multiple processor systems, and/or a coprocessor. Such auxiliary processors may be discrete processors or may be integrated with the processor 310. Examples of processors that may be used with the system 300 include, without limitation, any of the processors (e.g., Pentium™, Core i7™, Xeon™, etc.) available from Intel Corporation of Santa Clara, Calif., any of the processors available from Advanced Micro Devices, Incorporated (AMD) of Santa Clara, Calif., any of the processors (e.g., A series, M series, etc.) available from Apple Inc. of Cupertino, any of the processors (e.g., Exynos™) available from Samsung Electronics Co., Ltd., of Seoul, South Korea, any of the processors available from NXP Semiconductors N.V. of Eindhoven, Netherlands, and/or the like.

The processor 310 is preferably connected to a communication bus 305. The communication bus 305 may include a data channel for facilitating information transfer between storage and other peripheral components of the system 300. Furthermore, the communication bus 305 may provide a set of signals used for communication with the processor 310, including a data bus, address bus, and/or control bus (not shown). The communication bus 305 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 2788 general-purpose interface bus (GPIB), IEEE 696/S-100, and/or the like.

The system 300 preferably includes a main memory 315 and may also include a secondary memory 320. The main memory 315 provides storage of instructions and data for programs executing on the processor 310, such as any of the software discussed herein. It should be understood that programs stored in the memory and executed by the processor 310 may be written and/or compiled according to any suitable language, including without limitation C/C++, Java, JavaScript, Perl, Visual Basic, .NET, and the like. The main memory 315 is typically a semiconductor-based memory, such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

The secondary memory 320 is a non-transitory computer-readable medium having computer-executable code (e.g., any of the software disclosed herein) and/or other data stored thereon. The computer software or data stored on the secondary memory 320 is read into the main memory 315 for execution by the processor 310. The secondary memory 320 may include, for example, semiconductor-based memory, such as programmable read-only memory (PROM), erasable programmable read-only memory (EPROM), electrically erasable read-only memory (EEPROM), and flash memory (block-oriented memory similar to EEPROM).

The secondary memory 320 may optionally include an internal medium 325 and/or a removable medium 330. The removable medium 330 may be read from and/or written to in any well-known manner. The removable medium 330 may be, for example, a magnetic tape drive, a compact disc (CD) drive, a digital versatile disc (DVD) drive, other optical drive, a flash memory drive, and/or the like.

In an embodiment, an input/output (I/O) interface 335 provides an interface between one or more components of the system 300 and one or more input and/or output devices. Example input devices include, without limitation, sensors, keyboards, touch screens or other touch-sensitive devices, cameras, biometric sensing devices, computer mice, trackballs, pen-based pointing devices, and/or the like. Examples of output devices include, without limitation, other processing devices, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch panel display (e.g., in a smartphone, tablet computer, or other mobile device).

The system 300 may include a communication interface 340. The communication interface 340 allows software and data to be transferred between the system 300 and external devices (e.g. printers), networks, or other information sources. For example, computer software or executable code may be transferred to the system 300 from a network server (e.g., the platform 110 of FIG. 1) via the communication interface 340. Examples of the communication interface 340 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing the system 300 with a network (e.g., the network 140 of FIG. 1) or another computing device. The communication interface 340 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via the communication interface 340 are generally in the form of electrical communication signals 355. The electrical communication signals 355 may be provided to the communication interface 340 via a communication channel 350. In an embodiment, the communication channel 350 may be a wired or wireless network (e.g., the network 140), or any variety of other communication links. The communication channel 350 carries the electrical communication signals 355 and can be implemented using a variety of wired or wireless communication means including wire or cable, fiber optics, conventional phone line, cellular phone link, wireless data communication link, radio frequency (“RF”) link, or infrared link, just to name a few.

Computer-executable code (e.g., computer programs, such as the disclosed software) is stored in the main memory 315 and/or the secondary memory 320. Computer-executable code can also be received via the communication interface 340 and stored in the main memory 315 and/or the secondary memory 320. Such computer programs, when executed, enable the system 300 to perform various functions of the disclosed embodiments as described elsewhere herein.

In this description, the term “computer-readable medium” is used to refer to any non-transitory computer-readable storage media used to provide computer-executable code and/or other data to or within the system 300. Examples of such media include the main memory 315, the secondary memory 320 (including the internal medium 325 and/or the removable medium 330), the external storage medium 345, and any peripheral device communicatively coupled with the communication interface 340 (including a network information server or other network device). These non-transitory computer-readable media are means for providing software and/or other data to the system 300.

The system 300 may also include optional wireless communication components that facilitate wireless communication over a voice network and/or a data network (e.g., in the case of the user system 120, the customer system 130, and/or the user system 200). The wireless communication components comprise an antenna system 370, a radio system 365, and a baseband system 360. The baseband system 360 is communicatively coupled with the processor 310. In the system 300, radio frequency (RF) signals are transmitted and received over the air by antenna system 370 under the management of the radio system 365.

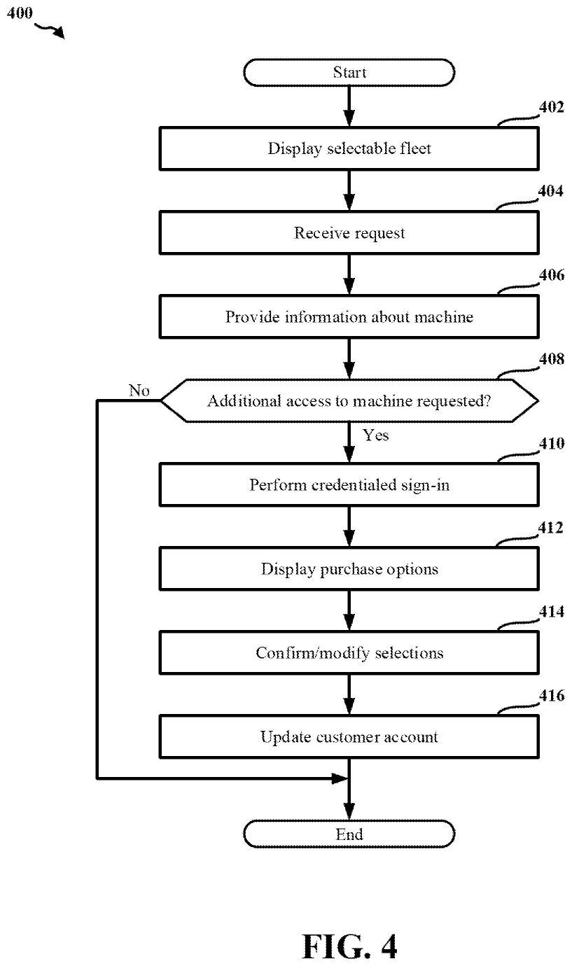

FIG. 4 illustrates a process 400 for facilitating a fleet selectable learning environment with a learning management system, according to an embodiment. The process 400 may be implemented by the server application 112 on the platform 110 (e.g., comprising the system 300). Any of the user operations and interactions described herein, such as the input of data by a user during any portion of process 400, may be performed via a graphical user interface that is generated by the server application 112, the client application 122, and/or a combination of the server application 112 and the client application 122.

While the process 400 is illustrated with a certain arrangement and ordering of subprocesses, the process 400 may be implemented with fewer, more, or different subprocesses and a different arrangement and/or ordering of subprocesses. In addition, any subprocess, which does not depend on the completion of another subprocess, may be executed before, after, or in parallel with that other independent subprocess, even if the subprocesses are described or illustrated in a particular order.

Initially, in subprocess 402, a fleet of selectable machines is displayed to a customer. The fleet of selectable vehicles may include one or more machines. The platform 110 may provide data regarding the fleet of selectable vehicles to the client application 122 for presentment via the display screen 204 of the user system 200.

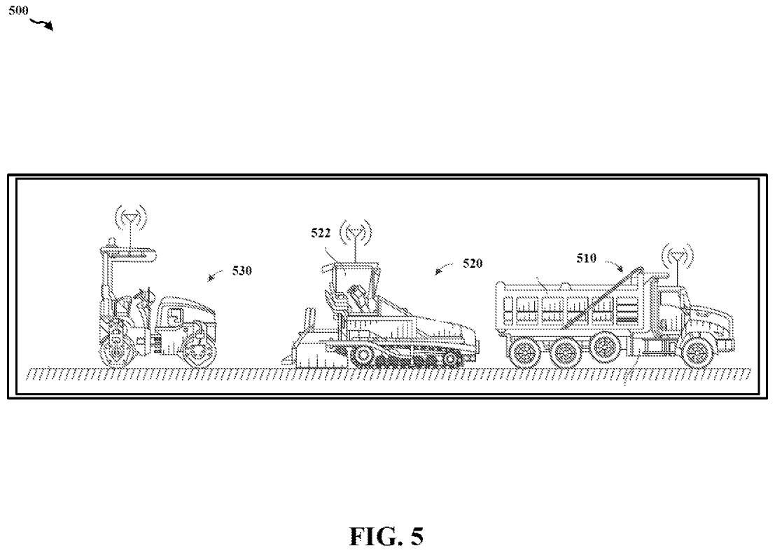

FIG. 5 illustrates an example machines fleet 500 including one or more selectable machines, as presented herein. The one or more selectable machines may be machines that are available for purchase or for which additional information may be available. For example, one or more of the selectable machines may have training scenarios that may be purchased or accessed. In the illustrated example of FIG. 5, the machines fleet 500 includes a haul trucker 510, a paving machine 520 (“paver”), and a compacting machine 530 (“compactor”). However, other examples may include additional or alternate machines. Each of the machines of the machines fleet 500 may be selectable, for example, via the one or more navigation controls 222 of the hand controls 220.

Returning to the example process 400 of FIG. 4, at subprocess 404, a request for information about a machine may be received from the customer. The customer may submit the request to the platform 110 via the user system 200 of the customer. For example, the customer may navigate the hand controls 220 to select a machine of the machines fleet 500 displayed via a graphical user interface. The customer may then submit the request for information about a machine using the one or more navigation controls 222 to select a machine. The request may include an identifier of the selected machine.

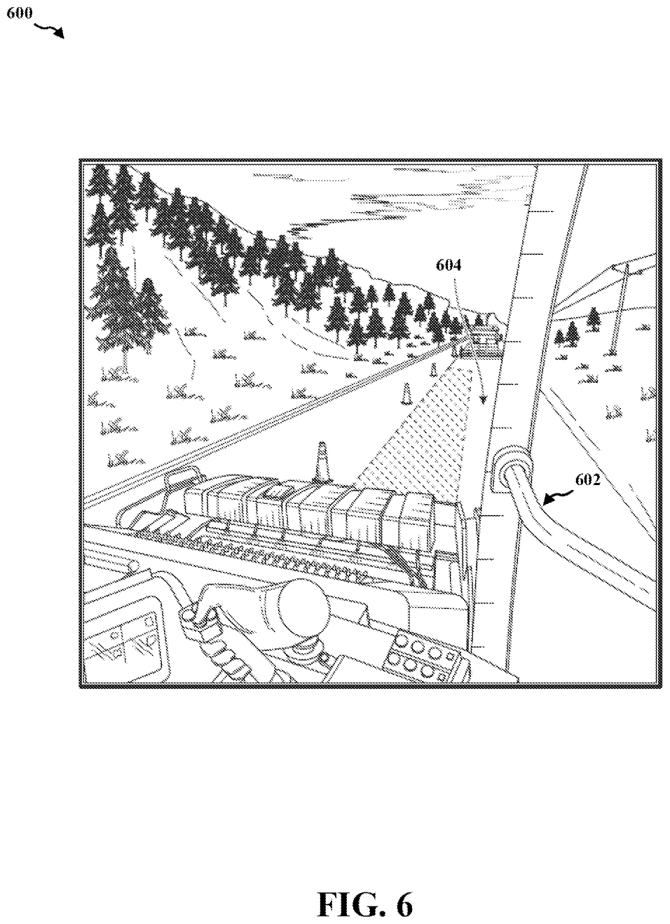

In some examples, when the customer selects a machine, the customer may be presented with a graphical user interface that simulates the customer in an operator station of the machine. For example, if the customer selects the paving machine 520 of the machines fleet 500 of FIG. 5, the customer may be presented with a field of view as if they were sitting in an operator station 522 of the paving machine 520. FIG. 6 illustrates a graphical user interface 600 including a field of view of the customer sitting in a virtual operator station 602 of a machine, as presented herein. As shown in FIG. 6, the customer is able to see certain controls (e.g., buttons, inputs, wheels, etc.) that the customer may see when seated in the operator station of the machine, such as the operator station 522 of the paving machine 520. The customer may also be able to determine a height of the 602 relative to a path 604.

Returning to the example process 400 of FIG. 4, at subprocess 406, the customer may be provided machine-related information about the machine. The platform 110 may retrieve the machine-related information from a data store (e.g., in the one or more databases 114) that is associated with the machine. The machine-related information may include technical information, such as technical manuals, equipment diagrams, diagnostics charts, analytics reports, and/or other machine-readable, textual, and/or graphical information relevant to the machine. The machine-related information may additionally or alternatively include information regarding how to operate the machine and/or how to fix the machine.

In some examples, the machine-related information provided to the customer may be a portion of the machine-related information available to the platform 110. For example, the machine-related information may display one or more training scenarios that may be associated with the machine. The one or more training scenarios may include, for example, machine walkarounds, various machine operation scenarios, various machine fixing scenarios, etc. However, access to the one or more training scenarios or the available machine-related information may be accessible via a purchase.

At subprocess 408, a determination is made whether additional access to the machine is requested. For example, the customer may select an input to see more information or to make a purchase related to the machine-related information. The customer may select the input using the hand controls 220 of the user system 200. If, at subprocess 408, the platform 110 determines that additional access to the machine is not requested, then the example process 400 of FIG. ends.

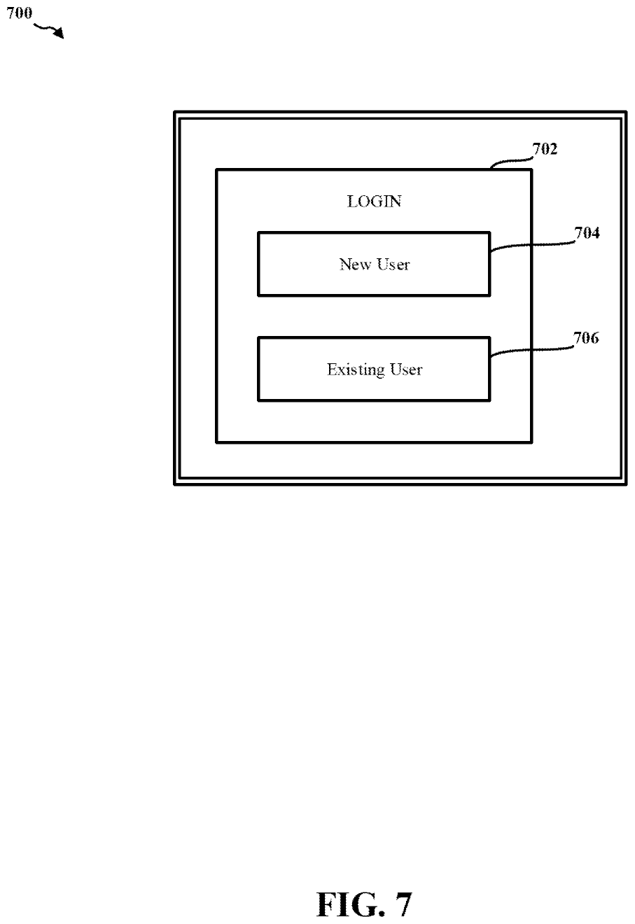

If, at subprocess 408, additional access to the machine is requested, then, at subprocess 410, a credentialed sign-in procedure is performed. For example, the customer may login to a user profile, associated with the customer, on the platform 110. FIG. 7 illustrates an example login window 702 to facilitate a credentialed sign-in procedure, as presented herein. In the example of FIG. 7, the login window 702 includes a first option 704 (“New User”) that is selectable for customers who are new users and a second option 706 (“Existing User”) that is selectable for customers with existing customer accounts (e.g., accessible to the platform 110). Based on the profile status of the customer (e.g., “New” or “Existing”), the customer may select the first option 704 or the second option 706 and continue with the credentialed sign-in procedure. For example, if the customer selects the first option 704, the customer may be prompted to enter user information, such as a name, contact information, company information, credentials (e.g., a user name and password, etc.), and/or payment options. After providing the user information (e.g., via the user system 200), the user information may be provided to the platform 110, which may then create a new customer account in a data store (e.g., in the one or more databases 114) that is associated with customer accounts.

Otherwise, if the customer selects the second option 706, the customer may be prompted to enter their credentials to access their user profile. For example, the customer may use the user system 200 to input their credentials (e.g., a user name and password) that is received by the platform 110. The server application 112 may confirm the credentials with customer account stored in a data store (e.g., in the one or more databases 114) that is associated with customer accounts. If the credentials are incorrect (e.g., do not match any credentials stored in the data store associated with user profiles), the server application 112 may prompt, via the client application 122, the customer to re-enter their credentials or to create a new user profile.

After the customer performs the credentialed sign-in procedure and the credentials of the customer are verified (e.g., at the subprocess 410), then at subprocess 412, one or more purchase options may be displayed to the customer. For example, the customer may be presented with an option to make a one-time payment, or may be presented with an option to make reoccurring payments, for example, via a subscription plan. The reoccurring payments may be based on any suitable period, such as monthly, semi-yearly, yearly, etc.

At subprocess 414, a selection of a purchase option may be confirmed and/or modified. For example, the platform 110 may cause the client application 122 to display one or more screens of a graphical user interface providing a summary of the potential purchase to the customer. The one or more screens of the graphical user interface may also provide options for the customer to modify any of the potential purchases. The customer may confirm their purchase by providing a confirmation input using one of the or more screens of the graphical user interface. The confirmation input may be received by the platform 110. The confirmation input may include information about the customer, such as the username of their credentials or an identifier associated with their credentials, and information about the purchase, such as the selected purchase option and an identifier for the machine for which the additional machine-related information is purchased.

At subprocess 416, the customer account is updated. For example, the platform 110 may update the customer account in the data store (e.g., in the one or more databases 114) that is associated with customer accounts to indicate that the customer has purchased the additional machine-related information. In some examples, the platform 110 may also update the customer account associated with the customer at the customer system 130. The example process 400 of FIG. 4 may then end.

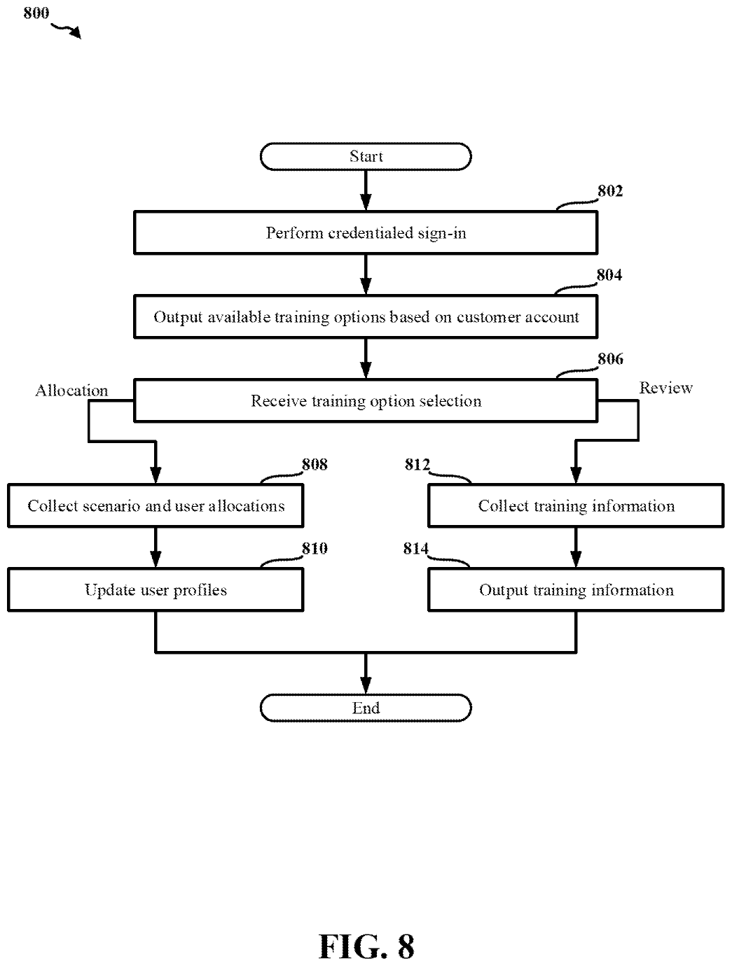

FIG. 8 illustrates a process 800 for facilitating a fleet selectable learning environment with a learning management system, according to an embodiment. For example, the process 800 may facilitate assigning training assignments to users and/or track and review assessments across different machines associated with the customer. The process 800 may be implemented by the customer application 132 on the customer system 130 (e.g., comprising the system 300). Any of the user operations and interactions described herein, such as the input of data by a user during any portion of the process 800, may be performed via a graphical user interface that is generated by the server application 112, the customer application 132, and/or a combination of the server application 112 and the customer application 132.

While the process 800 is illustrated with a certain arrangement and ordering of subprocesses, the process 800 may be implemented with fewer, more, or different subprocesses and a different arrangement and/or ordering of subprocesses. In addition, any subprocess, which does not depend on the completion of another subprocess, may be executed before, after, or in parallel with that other independent subprocess, even if the subprocesses are described or illustrated in a particular order.

Initially, in subprocess 802, a credentialed sign-in procedure is performed. For example, the customer may submit their credentials (e.g., a user name and password combination) to the customer application 132 via the customer system 130. The customer application 132 may confirm the credentials by comparing the submitted credentials to one or more credentials stored in a data store (e.g., in the one or more local databases 134) associated with credentials. In some examples, the customer application 132 may provide the credentials to the server application 112 via the network 140 to verify the credentials. When the provided credentials do not match any of the stored credentials, the customer may be prompted to re-submit their credentials or to register a new account.

After the credentialed sign-in procedure is performed and the provided credentials are verified, at subprocess 804, available training options based on the customer account are output. For example, the customer application 132 may access the available training options from a data store (e.g., in the one or more local databases 134) associated with customer accounts and/or training options. In some examples, the data store associated with customer accounts may indicate the one or more training options available to each of the different customer accounts included in the data store. In some examples, the data store associated with training options may include different training options and indicate which customers may access the respective training options. It may be appreciated that accessing the data store associated with the customer accounts and/or the training options may be performed based on at least a portion of the credentials associated with the customer and/or a unique identifier associated with the customer. In some examples, the customer application 132 may access the available training options from the platform 110. For example, the customer application 132 may request the platform 110, via the network 140, to provide available training options associated with the customer account. In such cases, the request to the platform 110 may include at least a portion of the credentials associated with the customer and/or a unique identifier associated with the customer that the platform 110 may use to identity the training options available to the customer.

Examples of training options include allocating one or more training sessions and/or tracking and reviewing assessments of completed training sessions. The one or more training sessions may include offerings related to operator training, service training, safety training, and/or sales training. The one or more training sessions may be allocated to one or more users. In some examples, the one or more training sessions may be allocated based on a machine in a customer machine fleet (e.g., one or more machines for which the customer has access to the training sessions). Tracking and reviewing assessments of completed training sessions may be performed at a training session level, at a user level, at a machine level, and/or at a fleet level.

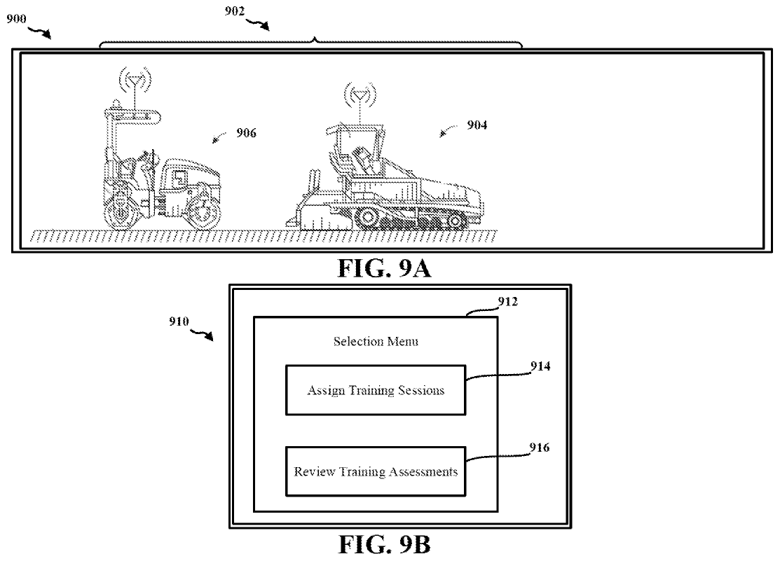

FIG. 9A illustrates a GUI 900 including customer machine fleet 902, as presented herein. In the example of FIG. 9, the customer has access to training sessions associated with a paving machine 904 and a compacting machine 906. The paving machine 904 may correspond to the paving machine 520, and the compacting machine 906 may correspond to the compacting machine 530 of FIG. 5. The customer may select one of the machines of the customer machine fleet 902 and be presented with one or more training options related to the selected machine. For example, the customer application 132 may receive a selection based on an input provided by the customer via the customer system 130. The selection may include an identifier associated with the machine. The customer application 132 may access then access the one or more training options associated with the selected machine.

FIG. 9B illustrates a GUI 910 illustrating available training options, as presented herein. In the example of FIG. 9B, the GUI 910 includes a selection menu 912 of the one or more available training options. For example, the selection menu 912 includes a first option 914 (“Assign Training Sessions”) to allocate one or more training sessions to users and a second option 916 (“Review Training Assessments”) to review assessments associated with completed training sessions. The assessments may include information collected at different levels, such as at a training session level, at a user level, at a machine level, and/or at a fleet level.

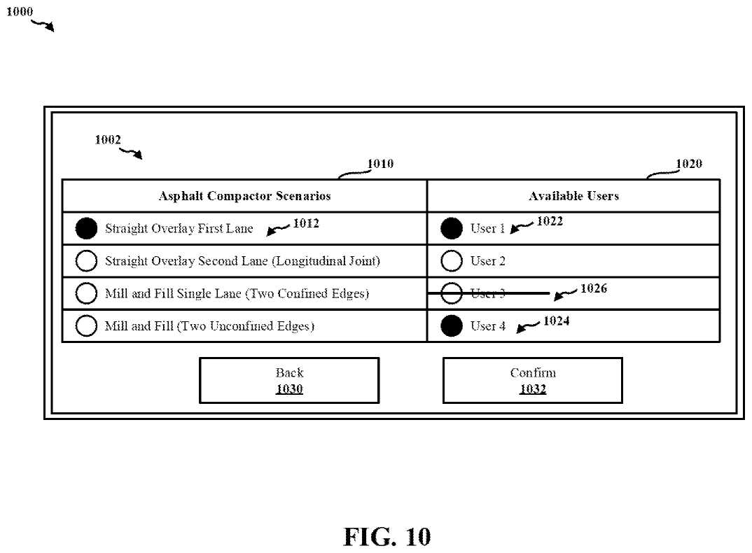

Returning to the example process 800 of FIG. 8, at subprocess 806, a training option selection is received. For example, the customer may submit their selection to the customer application 132 via the customer system 130. In a first example, the customer may select the first option 914 of FIG. 9 to allocate training sessions to users. For example, at subprocess 808, training session and user allocations may be collected. For example, the customer application 132 may output a listing of training sessions that the customer may select. The listing of training sessions may include all available training sessions or may include a subset of the available training sessions, for example, based on a selected machine. FIG. 10 illustrates a GUI 1000 including a training session allocation window 1002, as presented herein. The training session allocation window 1002 includes a first portion 1010 (“Asphalt Compactor Scenarios”) and a second portion 1020 (“Available Users”). The first portion 1010 indicates the one or more training sessions available for a machine. In the example of FIG. 10, the first portion 1010 includes four example training sessions associated with an asphalt compactor (e.g., the compacting machine 906 of FIG. 9). As shown in FIG. 10, a first scenario 1012 of the available training sessions are selected (e.g., as indicated by the filled-in circle next to the first scenario 1012).

The second portion 1020 indicates the one or more users who may be assigned the example scenarios included in the first portion 1010. In the example of FIG. 10, there are four example users from which the customer may select to assign the training sessions. The users included in the first portion 1010 may be populated based on users who are capable of operating the selected machine. For example, the customer application 132 may access user profiles in a data store (e.g., in the one or more local databases 134) associated with user profiles to determine which users are capable of operating which machines. As shown in FIG. 10, a first user 1022 (“User 1”) and a second user 1024 (“User 4”) are selected users to perform the first scenario 1012. In the example of FIG. 10, a third user 1026 (“User 3”) is crossed out to indicate that the respective user is unavailable to perform the selected scenario (e.g., the first scenario 1012). For example, the third user 1026 may have previously performed the scenario, or may not be expected to perform the scenario, etc.

The GUI 1000 also includes a first button 1030 (“Back”) to take the customer to a previous screen, such as the GUI 910 of FIG. 9B. The GUI 1000 also includes a second button 1032 (“Confirm”) to confirm the assignment of training sessions to users.

Returning to the example process 800 of FIG. 8, at subprocess 810, user profiles are updated. For example, the customer application 132 may update the user profiles in a data store (e.g., in the one or more local databases 134) associated with user profiles. In some examples, the user profile associated with a user may be updated when a training session is assigned to the user. In other examples, all of the user profiles may be updated to indicate that a training session was or was not assigned to a respective user. The example process 800 of FIG. 8 may then end.

Returning to the subprocess 806, in a second example, the customer may select the second option 916 of FIG. 9 to track and review assessments associated with completed training sessions. For example, at subprocess 812, training information may be collected. For example, the customer application 132 may collect training information regarding completed training sessions. The customer application 132 may collect the training information from a data store (e.g., in the one or more local databases 134) that may be associated with training assessments. The training information may include any assessment scores or feedback associated with completed training sessions. The assessment score may include a numerical value or a range providing an assessment on how the user performed in the training scenario. The feedback may include information providing information on user decisions relative to recommended decisions. For example, the feedback may include recommended settings versus user-selected setting so that the user is able to see how their decisions compare to the recommended decisions.

In some examples, the training information may be collected at a training session level. For example, at the training session level, the customer application 132 may collect training information related to which users completed the respective training session and which users have not completed the respective training session.

In some examples, the training information may be collected at a user level. For example, at the user level, the customer application 132 may collect training information related to which training sessions assigned to a user the respective user has completed, and which training sessions the respective has not completed.

In some examples, the training information may be collected at a machine level. For example, at the machine level, the customer application 132 may collect training information related to which training sessions associated with a machine have been completed and which training sessions associated with the respective machine have not been completed. The training information at the machine level may also include which users associated with the respective training sessions have completed or not completed the respective training sessions.

In some examples, the training information may be collected at a fleet level. For example, at the fleet level, the customer application 132 may collect training information related to which training sessions associated with each of the machines of the customer machine fleet have been completed and which training sessions associated with each of the machines of the customer machine fleet have not been completed. The training information at the fleet level may also include which users associated with the respective training sessions have completed or not completed the respective training sessions.

At subprocess 814, the training information is output. For example, the customer application 132 may output the collected training information to an output device of the customer system 130. The outputted training information may be at the training session level, at the user level, at the machine level, or at the fleet level. The example process 800 of FIG. 8 may then end.

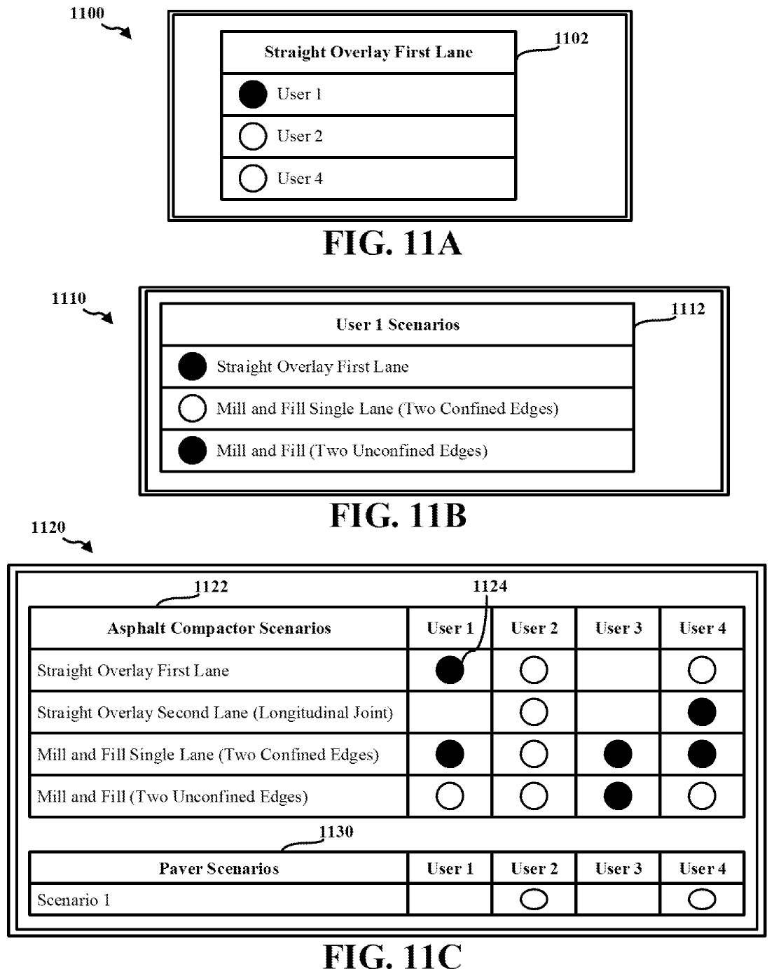

FIG. 11A illustrates a GUI 1100 including training information collected at a training session level, as presented herein. In the illustrated example of FIG. 11A, the GUI 1100 includes a scenario window 1102 that indicates a training scenario (“Straight Overlay First Lane”) for which training information is collected. For example, the scenario window 1102 indicates that are three users (e.g., a “User 1,” a “User 2,” and a “User 4”) assigned to perform the training scenario. The scenario window 1102 also indicates that the User 1 has completed the training scenario (e.g., as indicated by a filled-in circle) and that the User 2 and the User 4 have not yet completed the training scenario. In some examples, the customer may send a notification to the one or more users who have not completed the training scenario to remind them to complete the training scenario. The notification may include an internal message (e.g., using a messaging service implemented by the customer application 132 of the customer system 130) to a user account associated with the respective user, an email message to an email address associated with the respective user, a text message (e.g., using Short Message Service (SMS) or Multimedia Messaging Service (MMS)) to a mobile number associated with the respective user, and/or the like.

In some examples, for a user that has completed the training session (e.g., the User 1 of FIG. 11A), the customer may select their user name (e.g., “User 1”) to access information related to their performance of the training session. For example, selecting the user name may result in the client application 132 accessing the respective user profile in a data store (e.g., in the one or more local databases 134) associated with the user profile to retrieve score assessments, if any, and feedback based on the user completing the training session.

FIG. 11B illustrates a GUI 1110 including training information collected at a user level, as presented herein. In the illustrated example of FIG. 11B, the GUI 1110 includes a user scenarios window 1112 that indicates a user for which training information is collected. For example, the user scenarios window 1112 indicates that are three scenarios (e.g., a “Straight Overlay First Lane” scenario, a “Mill and Fill Single Lane (Two Confined Edges)” scenario, and a “Mill and Fill (Two Unconfined Edges)” scenario) assigned to be performed by the User 1. The user scenarios window 1112 also indicates that the User 1 has completed the first scenario and the third scenario (e.g., as indicated by a filled-in circle) and that the User 1 has not yet completed the second scenario. Similar to the example of FIG. 11A, in some examples, the customer may send a notification to the user to remind them to complete any incomplete training sessions. Additionally, the customer may select a completed scenario to access information related to the performance of the user when performing the training session. For example, selecting the first scenario may result in the client application 132 accessing the respective user profile in a data store (e.g., in the one or more local databases 134) associated with the user profile to retrieve score assessments, if any, and feedback based on the user completing the first session.

FIG. 11C illustrates a GUI 1120 including training information collected at a machine level, as presented herein. In the illustrated example of FIG. 11C, the GUI 1120 includes a machine scenarios window 1122 that indicates one or more training scenarios associated with a machine. For example the machine scenarios window 1122 indicates that there are four training scenarios (e.g., a “Straight Overlay First Lane” scenario, a “Straight Overlay Second Lane (Longitudinal Joint” scenario, a “Mill and Fill Single Lane (Two Confined Edges)” scenario, and a “Mill and Fill (Two Unconfined Edges)” scenario) associated with the Asphalt Compactor. The machine scenarios window 1122 also indicates the different users (e.g., a “User 1,” a “User 2,” a “User 3,” and a “User 4”) that may be assigned one or more of the training scenarios. For example, as shown in FIG. 11C, the User 1 is assigned the first scenario, the third scenario, and the fourth scenario, has completed the first scenario and the third scenario, and has not yet completed the fourth scenario. The User 2 of FIG. 11C is assigned each of the four scenarios and has not yet completed any of the four scenarios. The User 3 of FIG. 11C is assigned the third scenario and the fourth scenario, and has completed each of the assigned scenario. The User 4 of FIG. 11C is assigned each of the four scenarios, has completed the second scenario and the third scenario, and has not yet completed the first scenario and the fourth scenario.

Similar to the example of FIG. 11A, in some examples, the customer may send a notification to a user to remind the user to complete any incomplete training sessions. Additionally, the customer may select a completed scenario and user name to access information related to the performance of the user when performing the respective training session. For example, selecting a first option 1124 may result in the client application 132 accessing the respective user profile in a data store (e.g., in the one or more local databases 134) associated with the user profile to retrieve score assessments, if any, and feedback based on the user completing the first session.

In some examples, the customer may select a scenario of the machine scenarios window 1122 and be presented with collected information associated with the selected scenario. For example, the customer may select first scenario and be presented with collected information related to the first scenario, as described in connection with the scenario window 1102 of FIG. 11A. In some examples, the customer may select a user of the machine scenarios window 1122 and be presented with collected information associated with the selected user. For example, the customer may select the User 1 and be presented with collected information related to the User 1, as described in connection with the user scenarios window 1112 of FIG. 11B.

In some examples, the client application 132 may present collected information at a fleet level. For example, the customer application 132 may output a GUI including a fleet scenarios window that includes collected information for the one or more machines associated with the customer (e.g., the customer machine fleet 902 of FIG. 9), collected information for the one or more training scenarios associated with each of the machines, and collected information for the users assigned any of the one or more training scenarios associated with each of the machines.

In the illustrated example of FIG. 11C, the collected information at the fleet level may be output as different screens or windows of the GUI 1120. For example, the machine scenarios window 1122 may be part of a first screen and provide training scenario tracking related to the different users and the Asphalt Compactor. A second screen of the GUI 1120 may include a second machine scenarios window 1130 associated with a second machine (e.g., a “Paver”) and indicate the one or more scenarios associated with the second machine, and indicate the users assigned to any of the one or more training scenarios associated with the second machine. In a similar manner, additional machine scenarios windows may be presented for the different machines of the customer machine fleet 902.

In some examples, the customer may change the displaying of the training information from a first level to a second level. In such examples, control may return to subprocess 812 to collect the appropriate training information.

It may be appreciated that in some examples, after the user profiles are updated (e.g., at the subprocess 810) or the training information is output (e.g., at the subprocess 814), control may return to the subprocess 804 to output available training options based on the customer account. That is, instead of the process 800 ending, control may return to a previous screen to allow the customer to perform additional operations or tasks associated with the training options. In such examples, the customer may select an Exit option to exit the process 800 of FIG. 8.

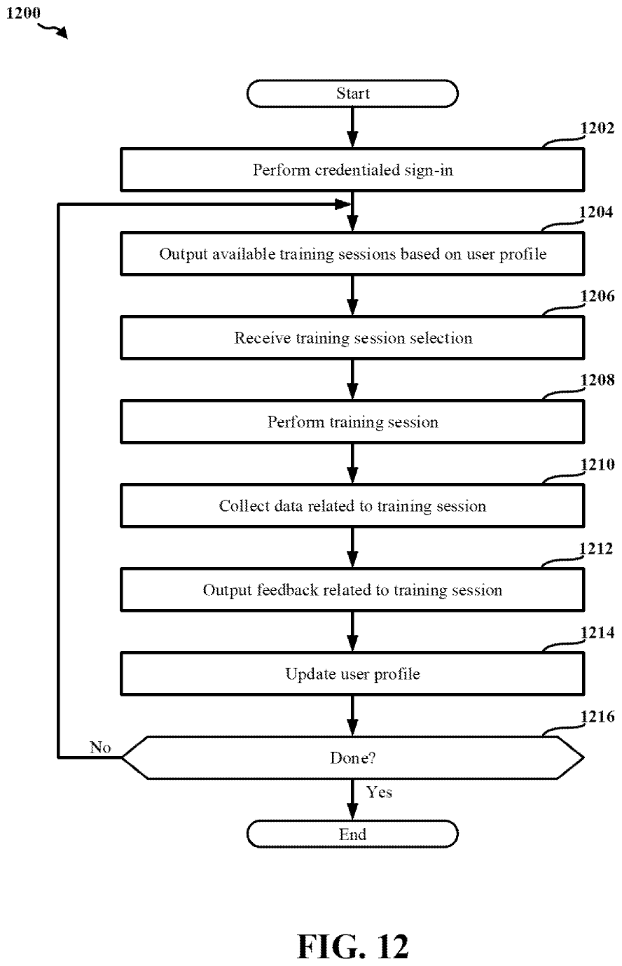

FIG. 12 illustrates a process 1200 for facilitating a fleet selectable learning environment with a learning management system, according to an embodiment. For example, the process 1200 may facilitate reviewing and performing training sessions based on a user. The process 1200 may be implemented by the client application 122 on the user system 120 or the user system 200 (e.g., comprising the system 300). Any of the user operations and interactions described herein, such as the input of data by a user during any portion of the process 1200, may be performed via a graphical user interface that is generated by the server application 112, the client application 122, the customer application 132, and/or a combination of the server application 112, the client application 122, and the customer application 132.

While the process 1200 is illustrated with a certain arrangement and ordering of subprocesses, the process 1200 may be implemented with fewer, more, or different subprocesses and a different arrangement and/or ordering of subprocesses. In addition, any subprocess, which does not depend on the completion of another subprocess, may be executed before, after, or in parallel with that other independent subprocess, even if the subprocesses are described or illustrated in a particular order.

Initially, in subprocess 1202, a credentialed sign-in procedure is performed. For example, the user may submit their credentials (e.g., a user name and password combination) to the client application 122 via the user system 120. The client application 122 may confirm the credentials by comparing the submitted credentials to one or more credentials stored in a data store (e.g., in the one or more local databases 124) associated with credentials. In some examples, the client application 122 may provide the credentials to the customer application 132 via the network 140 to verify the credentials. When the provided credentials do not match any of the stored credentials, the user may be prompted to re-submit their credentials or to register a new account.

After the credentialed sign-in procedure is performed and the provided credentials are verified, at subprocess 1204, available training sessions based on the user profile are output. For example, the client application 122 may access the available training sessions from a data store (e., in the one or more local databases 124) associated with training sessions. In some examples, the client application 122 may access the available training sessions from the customer system 130. For example, the client application 122 may request the customer system 130, via the network 140, to provide available training sessions associated with the user profile. In such cases, the request to the customer system 130 may include at least a portion of the credentials associated with the user and/or a unique identifier associated with the user that the customer system 130 may use to identity the training sessions available to the user.

As described above in connection with the first portion 1010 of FIG. 10, the training sessions may be associated with a particular machine. For example, the training sessions of the first portion 1010 are associated with an Asphalt Compactor. In other examples, the training sessions output to the user may include training sessions associated with different machines. For example, the user may be assigned a first set of training sessions associated with a first machine and a second set of training sessions associated with a second machine. In such examples, the output of training sessions (e.g., at the subprocess 1204) may include the first set of training sessions and the second set of training sessions. The first set of training sessions and the second set of training sessions may each include one or more training sessions.

In some examples, the output of training sessions may indicate which of the assigned training sessions the user has completed and which of the assigned training sessions are still to be completed.

At subprocess 1206, a training scenario selection is received. For example, the user may submit their selection to the client application 122 via the user system 120.

At subprocess 1208, the training session may be performed. For example, the client application 122 may output screens of a graphical user interface to train the user through the training session. In some examples, performing the training session may include performing a guided operator training session. In such examples, the training session may include guides to help assist the user as they perform the training session. In other examples, the performing the training session may include performing an assessment operator training session. In such examples, the training session may forego the guides to help assist the user as they perform the training session. In some examples, the user may receive feedback when the user performs the guided operator training session or the assessment operator training session. In some examples, the user may receive an assessment score when the user performs the assessment operator training session and not when the user performs the guided operator training session. Example implementations of performing a training session are described in co-pending U.S. Patent Application Attorney Docket No. 21-1156, filed on Mar. 11, 2022, and entitled “Guided Operator Virtual Reality Trainer.”

At subprocess 1210, data related to the training session is collected. For example, the client application 122 may collect data related to how the user performed in the training scenario from the user system 120. The data may include user-selected decisions and/or interactive aspects, such as following a path. The client application 122 may store the collected data in a data store (e.g., in the one or more local databases 124) associated with the user profile and/or the training sessions.

At subprocess 1212, feedback related to the training session may be output. For example, the user system 120 may output feedback based on the collected data (e.g., at the subprocess 1212). The feedback may include comparisons between recommended settings and user-selected settings, comparisons between a scenario path and a path taken by the user, etc. The feedback may also include coaching on different techniques to improve performance when performing the training session. In some examples, the feedback may also include an assessment score. The assessment score may include a numerical value or represent a range of values. For example, a first assessment score of “Excellent” may indicate a range of scores between 91% and 100%, a second assessment score of “Great” may indicate a range of scores between 81% and 90%, etc.

At subprocess 1214, the user profile of the user may be updated. For example, the client application 122 may update the user profile in the data store (e.g., in the one or more local databases 124) associated with user profiles. The updated user profile may include an indication that the user completed the respective training scenario. The updated user profile may also include an assessment score, if available, and feedback provided to the user.

At subprocess 1216, a determination is made on whether the user is done. For example, the user may submit a selection to the client application 122 via the user system 120. The selection may indicate to continue the training sessions or to exit the training sessions. If, at subprocess 1216, the selection is to continue the training sessions, then control returns to subprocess 1204 and available training sessions based on the user profile are output. If, at subprocess 1216, the selection is to exit the training sessions, then the example process 1200 of FIG. 12 ends.

### INDUSTRIAL APPLICABILITY

Operators of a machine at a work site may be trained to operate the respective machine. However, as the size of a customer grows in terms of machines and/or employees, it may become different to determine which employees (or users) have been trained on which machines and with which training scenarios.

Aspects disclosed herein provide a learning environment that encompasses a broad spectrum of machines and technology that may be beneficial to a customer. The learning environment may be a virtual reality environment, for example accessed via the user system 200 of FIG. 2. The learning environment may be accessed via credentialed sign-in procedures associated with an account. The learning environment may then provide a tailored experience based on the account. For example, the learning environment may present machine-related information applicable to the account. In some examples, the learning environment may present training options based on the account. For example, the training options may include one or more training scenarios based on machines associated with the account. For example, if an asphalt compactor is registered with the account, the training scenarios may include one or more training scenarios related to an asphalt compactor. The learning environment may also provide a tracking tool to enable a customer to track and review assessments across a broad range of levels, such as at a training session level, at a user level, at a machine level, and/or at a fleet level. The machine-related information, the training options, and the tracking tool may each be respectively linked to the account accessed via the credentialed sign-in procedure.

Notably, the disclosed aspects provide a learning management system that enables access to one or more training scenarios, such as operator training scenarios, service training scenarios, safety training scenarios, and/or sales training scenarios, via a learning environment and that also provides techniques to track and review assessments associated with the one or more training scenarios. Thus, aspects disclosed herein provide a solution for offering and managing training scenarios related to a fleet of machines within a learning environment and without the cost associated with stand-alone devices and/or traveling to off-site locations, while also providing a consistent training experience that may be updated as the scope of the customer adjusts (e.g., grows with new machines and/or employees).

It will be understood that the benefits and advantages described above may relate to one embodiment or may relate to several embodiments. Aspects described in connection with one embodiment are intended to be able to be used with the other embodiments. Any explanation in connection with one embodiment applies to similar features of the other embodiments, and elements of multiple embodiments can be combined to form other embodiments. The embodiments are not limited to those that solve any or all of the stated problems or those that have any or all of the stated benefits and advantages.

The preceding detailed description is merely exemplary in nature and is not intended to limit the invention or the application and uses of the invention. The described embodiments are not limited to usage in conjunction with a particular type of machine. Hence, although the present embodiments are, for convenience of explanation, depicted and described as being implemented for work site machinery, it will be appreciated that the present embodiments can be implemented for various other types of machines, and in various other systems and environments. Furthermore, there is no intention to be bound by any theory presented in any preceding section. It is also understood that the illustrations may include exaggerated dimensions and graphical representation to better illustrate the referenced items shown, and are not considered limiting unless expressly stated as such.

1. A computer-implemented method for management of training scenarios for machines associated with a customer, the computer-implemented method comprising:
performing a credentialed sign-in procedure based on credentials associated with a first user account of a first user;
outputting at least one training option based on the first user account when the credentials are verified, wherein the at least one training option includes a first training option of assigning a training scenario to a second user and a second training option of outputting an assessment of a training session completed by the second user based on an assigned training scenario, wherein the training scenarios available for assigning are based upon machines associated with the first user account;
collecting information related to a first training option when the first training option is selected, the information including at least one of a second user assignment or the assessment; and
collecting assignments based on a first set of training sessions and a second set of users based on selection of the first training option, the first set of training sessions including one or more training sessions for one or more machines associated with the first user account, the second set of users including one or more second users selected to operate the one or more machines,
wherein training sessions include machine walkarounds, machine operation training, and application training for the one or more machines associated with the first user account.

2. The computer-implemented method of claim 1, wherein the credentials include a first user name and password combination.

3. The computer-implemented method of claim 1, wherein outputting the at least one training option includes:
accessing a data store associated with at least one of accounts or training options; and
retrieving the at least one training option from the data store.

4. The computer-implemented method of claim 3, further including:
using an identifier associated with the first user account to access the data store.

5. (canceled)

6. The computer-implemented method of claim 1, wherein the training scenario includes at least one of an operator training scenario, a service training scenario, a safety training scenario, and a sales training scenario.

7. (canceled)

8. The computer-implemented method of claim 1, further including:
updating second user profiles associated with respective second users of the second set of users indicating training sessions of the first set of training sessions assigned to the respective second users.

9. The computer-implemented method of claim 1, further including:
collecting training information based on completed training sessions; and
outputting the training information as the assessment.

10. The computer-implemented method of claim 9, wherein the training information is collected at least at one of a training scenario level, a second user level, a machine level, and a fleet level.

11. The computer-implemented method of claim 9, wherein the assessment includes at least one of a score assessment and feedback.

12. The computer-implemented method of claim 1, further including:
outputting a representation of one or more machines associated with the first user account, each of the one or more machines being selectable to obtain machine-related information.

13. The computer-implemented method of claim 12, further including:
receiving a selection of a first machine of the one or more machines, and wherein the at least one training option is associated with the first machine.

14. The computer-implemented method of claim 1, wherein the at least one training option is output in a learning environment accessible via a virtual reality system.

15. A system for training scenarios, comprising:
a memory; and
at least one processor coupled to the memory, the at least one processor configured to:
perform a credentialed sign-in procedure based on credentials associated with a first user account;
output at least one training option based on the first user account when the credentials are verified, wherein the at least one training option includes a first training option of assigning a training scenario to a second user and a second training option of outputting an assessment of a training session completed by the second user based on an assigned training scenario, wherein the training scenarios available for assigning are based upon machines associated with the first user account;
collect information related to a first training option when the first training option is selected, the information including at least one of the second user assignment or the assessment; and
collect assignments based on a first set of training sessions and a second set of users based on selection of the first training option, the first set of training sessions including one or more training sessions for one or more machines associated with the first user account, the second set of users including one or more second users selected to operate the one or more machines,
wherein training scenarios include machine walkarounds, machine operation training, and application training for the one or more machines associated with the first user account.

16. The system of claim 15, wherein to output the at least one training option, the at least one processor is configured to:
access a data store associated with at least one of accounts or training options; and
retrieve the at least one training option from the data store.

17. (canceled)

18. The system of claim 15, wherein the at least one processor is further configured to:
update second user profiles associated with respective second users of the second set of users indicating training sessions of the first set of training sessions assigned to the respective second users.

19. The system of claim 15, wherein the at least one processor is further configured to:
collect training information based on completed training sessions; and
output the training information as the assessment.

20. A non-transitory computer-readable medium having instructions stored therein, wherein the instructions, when executed, cause a processor to:
perform a credentialed sign-in procedure based on credentials associated with a user account;
output at least one training option based on the first user account when the credentials are verified, wherein the at least one training option includes a first training option of assigning a training scenario to a second user and a second training option of outputting an assessment of a training session completed by the second user based on an assigned training scenario, wherein the training scenarios available for assigning are based upon machines associated with the first user account;
collect information related to a first training option when the first training option is selected, the information including at least one of the second user assignment or the assessment; and
collect a first set of training sessions and a second set of users based on selection of the first training option, the first set of training sessions including one or more training sessions for one or more machines associated with the first user account, the second set of users including one or more second users selected to operate the one or more machines,
wherein training scenarios include machine walkarounds, machine operation training, and application training for the one or more machines associated with the first user account.
